(19) United States
(12) Patent Application Publication
(10) Pub. No.: US 2002/0052566 A1
(43) Pub. Date: May 2, 2002

(54) Therapeutic pad

(76) Inventor: Alberta H. Sequeira, Rochester, MA (US)

Correspondence Address: Richard C. Litman, LITMAN LAW OFFICES, LTD., P.O. Box 15035, Arlington, VA, 22215, US

(21) Appl. No.: 09/985,054

(22) Filed: Nov. 1, 2001

Related U.S. Application Data
(60) Provisional application No. 60/245,067, filed on Nov. 2, 2000.

(51) Int. Cl. A61H 15/00

(52) U.S. Cl. 601/112

(57) ABSTRACT

A therapeutic pad having a U-shaped configuration with parallel legs and a gel containing insert which can be cooled or heated for relief of neck or shoulder pain. The pad is fastened around one's neck by hook and loop fastening patches on the legs.

This application claims the benefit of U.S. Provisional Patent Application Serial No. 60/245,067 filed Nov. 2, 2000.

### BACKGROUND OF THE INVENTION

1. Field of the Invention

The present invention relates generally to a therapeutic devices and, more specifically, to a therapeutic device comprising a heated or chilled gel pack in a U-shaped cover with the sleeve ends having hook and loop closure patches. The gel pack can be applied to the upper back, neck, shoulders, and chest, while the gel pack is positioned securely but loosely around the user's neck.

2. Description of the Related Art

The related art of interest describes various therapeutic devices of various shapes, but none discloses the present invention. There is a need for a versatile and economical heated or cooled gel pack which can be conveniently placed on one's neck or shoulders and fastened to remain in that position until the need no longer exists, whereupon the gel pack can be readily removed. The related art will be discussed in the order of perceived relevance to the present invention.

U.S. Pat. No. 5,247,928 issued on Sep. 28, 1993, to Jerry D. Stilts, Jr. describes a therapeutic collar comprising an elongated straight flexible piece containing a flexible plastic container with crushed ice or a heat inducing chemical material by accessing by an overlapping flap on an upper outside surface which has a slogan indicia or a design. The collar ends are secured with a pair of snaps, because hook and loop fastening does not work well in the presence of moisture. The device is distinguishable for being limited to a required closing flap, use of ice or a heat inducing chemical material, and the negative teaching of utilizing closing snaps instead of hook and loop fastening.

U.S. Pat. No. 5,507,793 issued on Apr. 16, 1996, to Terry L. Hodges describes an elongated straight non-restricting neck wrap having wider ends comprising four pockets centered with a folded over cover. The upper central surface of the wrap has an opening for access to the four pockets containing cooling or heating packets of ice or an air activated heating pad supplying an even temperature of about 135° F. for 10 hours. The neck wrap is secured around the neck by hook and loop fastening patches. An alternate embodiment has a U-shape with an enlarged U-shaped pouch containing a heat transfer unit in a polyvinyl chloride envelope having a centered zipper or slider opening similar to a freezer bag for adding ice. The neck wraps are distinguishable for requiring either pockets for small packets or a U-shaped packet with access by zipper or slider openings and secured with the ends parallel.

U.S. Pat. No. 4,527,565 issued on Jul. 9, 1985, to Billie J. Ellis describes a cold facial butterfly-shaped applicator or compress in the form of a mask comprising two sheets of flexible material bonded together at its edges and contains a gel. The mask has an aperture for the eyes and a lower notch for the nose. The gel comprises a silicate gel which is mixed with water and glycol. The device and gel are distinguishable for being limited to cold applications requiring a shape for the face and a silicate gel which resists freezing to a solid.

U.S. Pat. No. 5,395,399 issued on Mar. 7, 1995, to Mark A. Rosenwald describes a thermal wrap for a joints and limbs comprising a trapezoidal-shaped pouch made of a flexible elastic cloth and containing a pre-packaged gel which can be heated or chilled, ice, hot water or anti-freeze liquid. The pouch is closed on top by hook and loop fastening strips. The wrap has two flexible elastic straps on one side edge with hook and loop fastening patches. The sides of the wrap also have the same fastening patches. The thermal wrap is distinguishable for being restricted to wrapping around joints and limbs.

U.S. Pat. No. 6,129,659 issued on Oct. 10, 2000, to Bruce R. Wilk describes a cold therapy pad with a magnetotherapy unit comprising vinyl pads of different shapes for body joints, limbs, neck, waist, chest, and eyes containing silicate gel embedding magnets in a singular rectangular shape, an elliptical shape or in multiple aligned rectangular shapes. Each rectangular pad end has a pair of hook and loop fastening strips. Another configuration for the neck has a T-shaped magnet insert. The sundry shaped pads are distinguishable for requiring magnets and used only for cold therapy.

U.S. Pat. No. 4,756,311 issued on Jul. 12, 1988, to Sam E. Francis, Jr. describes a microwavable thermal compress and a method of using the gel package as a hot or cold pack. The envelope consists of an inner film of polyethylene and an outer layer of nylon or nylon sclair. The gel is formed from a mixture of sodium hydroxide solution with an aqueous Carbopol, propyleneglycol and formaldehyde mixture. This composition is utilized in the present invention.

U.S. Pat. No. 5,257,429 issued on Nov. 2, 1993, to Mark Genis describes a U-shaped therapeutic head and neck rest having a first pillow composed of a soft tufted cover filled with a cushion material joined by hook and loop fastening patches to a second pillow having a bladder filled with a warmed liquid. The device is distinguishable for requiring ice or a aqueous fill.

U.S. Pat. No. 5,571,155 issued on Nov. 5, 1996, to Gilles Bastille describes a U-shaped thermal pad comprising a porous fabric cover and filled with sterilized cereal grains which can be heated or cooled. The pad is distinguishable for its requirement for a grain filler to supply the heat or cold.

U.S. Pat. No. 5,728,146 issued on Mar. 17, 1998, to Timothy A. Burkett et al. describes a thermal neck wrap having a delta-winged aircraft shape containing a plurality of individual thermal elements consisting of iron powder, carbon powder, a metal salt, and 1-40% water. The neck wrap is distinguishable for its required individual thermal elements requiring water and metal powder, and the lack of a suggestion for tying the arms around the neck.

U.S. Pat. No. 6,123,717 issued on Sep. 26, 2000, to Leane K. Davis et al. describes a disposable bird-shaped thermal neck wrap having similar heat cells containing iron powder, etc. as above.

U.S. Design Pat. No. 428,153 issued on Jul. 11, 2000, to Leane K. Davis describes an ornamental planar knee wrap having an internal aperture and slot and an external slot with uneven legs at one end. The knee wrap is distinguishable for not requiring any internal heating or cooling elements.

U.S. Pat. No. 6,116,231 issued on Sep. 12, 2000, and U.S. Pat. No. 5,984,953 issued on Nov. 16, 1999, to Martin W. Sabin et al. describes a rectangular liquid heat pack utilizing an exothermic chemical reactant. The heat pack is distinguishable for being limited to a specific heating chemical filler.

U.S. Pat. No. 6,183,501 B1 issued on Feb. 6, 2001, to Jeffrey W. Latham describes a cooling system for the head, neck and spine caused by trauma to the brain. An external cooling device filled with any chemical coolant is supplied to the head piece. The system is distinguishable for requiring an external cooling fluid.

U.S. Pat. No. 5,344,437 issued on Sep. 6, 1994, to George R. Pistay describes a U-shaped massaging therapeutic pillow with a removable ice pack or heating medium and including a vibrator mechanism. The pillow is distinguishable for requiring vibrator means.

U.S. Pat. No. 6,185,744 B1 issued on Feb. 13, 2001, to Mike Poholski describes a rectangular shaped thermal vest with a notch for the neck which can be worn over the chest or the back, and comprises a shell with a thermal insert comprising ceramic beads, freezable liquid, heatable liquid or a “jell”. The thermal insert can have various shapes, but has an array of closed compartments in either a checkerboard or box quilting pattern. The thermal vest is distinguishable for requiring two separate garments and a thermal insert containing ceramic beads or various sealed liquids.

U.S. Design Pat. No. D446,863 S issued on Aug. 21, 2001, to Rosemary Carroll describes a combined therapeutic hot and cold compress comprising four planar panels connected by hook and loop fastening patches. The two side panels appear to be shoe-shaped bladders connected on top and the bottom by the straps. The compress device is distinguishable for being limited to the application of the hot or cold compress to two sides of a limb or face.

U.S. Pat. No. 3,889,684 issued on Jun. 17, 1975, to Steve Lebold describes a flexible variously shaped water retaining hot or cold absorbent pack combined by two terry cloth sides with hook and loop strips and straps around its edges. An inner pouch has a closure flap and made of polyethylene, polypropylene or vulcanized rubber which contains the hot water or ice water and an absorbent sheet of cellulose, felt or terry cloth. The pack device is distinguishable for its requirement for a closure flap and numerous straps.

U.S. Pat. No. 5,890,487 issued on Apr. 6, 1999, to Renee S. Kimmel describes a corn filled heating pad made of fabric of various shapes with and without straps for heating and cooling the body at the waist, chest and the like. The device is distinguishable for requiring a corn filled heating pad.

U.S. Pat. No. 5,916,088 issued on Jun. 29, 1999, to Martin Gueli describes a cooling beach pillow comprising a rectangular housing having a gel containing pocket, a freezer pack, thermal insulation, a recess, a timer, button-like side projections, and a strap. The pillow is distinguishable for being limited to cooling.

U.K. Patent Application No. 2 205 496 A published on Dec. 14, 1988, for Yuanwu Ni et al. describes a rectangular-shaped therapeutic pack for hot compress treatment of rheumatic fever, arthritis, scapulohumeral periarthritis and damage to tendon and soft tissues consists of a bag lined on its interior with a perforated plastic film and carries a drug and thermogenic materials such as iron powder, activated charcoal, vermiculite, silicon dioxide, sodium chloride, and water, and enclosed in a packet. The pack device is distinguishable for requiring different materials such as iron, charcoal, vermiculite, silicon dioxide, and drugs.

None of the above inventions and patents, taken either singularly or in combination, is seen to describe the instant invention as claimed. Thus, a therapeutic pad solving the aforementioned problems is desired.

### SUMMARY OF THE INVENTION

The present invention, versatile in effect and economical in cost, is a U-shaped gel pack that can be heated or cooled, and then be conveniently placed on one's neck or shoulders and fastened to remain securely but loosely in that position. Arthritis, sore muscles and the like physical ailments especially around the neck and torso can be alleviated by the use of this invention.

Accordingly, it is a principal object of the invention to provide a therapeutic device for physical ailments.

It is another object of the invention to provide a therapeutic device in the form of a gel pack which can be heated or cooled.

It is a further object of the invention to provide a therapeutic device which is U-shaped for easy attachment around a person's neck by the ends of the device.

Still another object of the invention is to provide a therapeutic device which can be fastened loosely but securely around one's neck.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a front environmental view of a therapeutic pad in use, and according to the present invention.

FIG. 2 is a top plan view of the therapeutic pad cover and a gel bag insert.

FIG. 3 is a side elevational view of the therapeutic pad placed around the shoulders.

FIG. 4 is a front perspective view showing the hook and loop patches of the therapeutic pad.

FIG. 5 is an exploded perspective view of the separated pad covers and the gel included insert.

Similar reference characters denote corresponding features consistently throughout the attached drawings.

### DETAILED DESCRIPTION OF THE PREFERRED EMBODIMENT

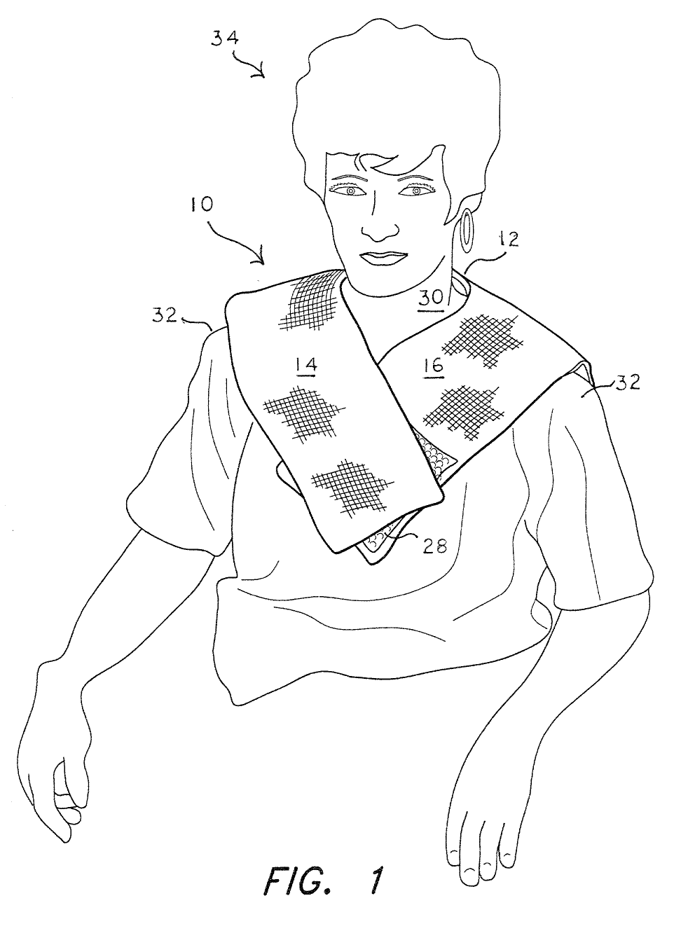

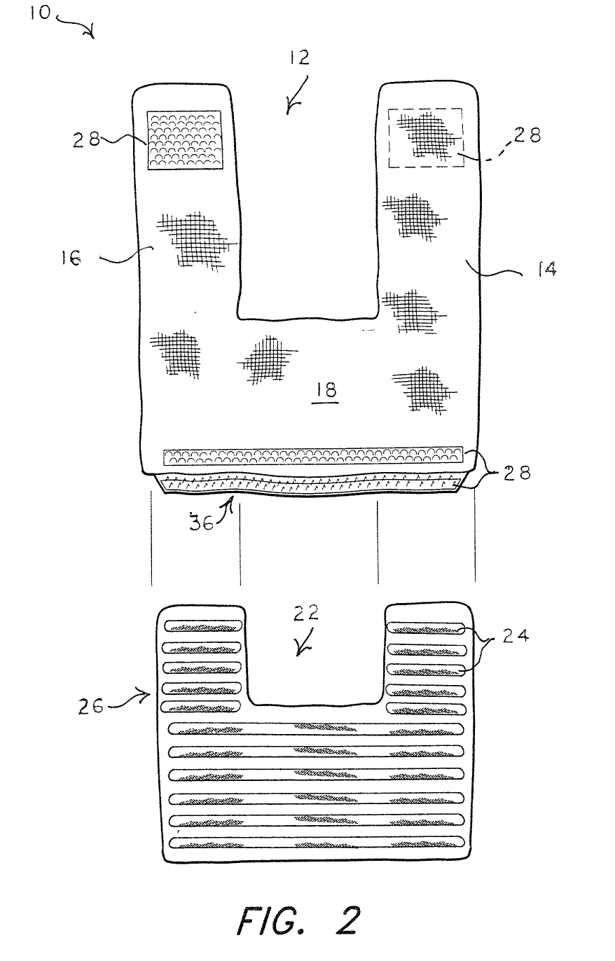

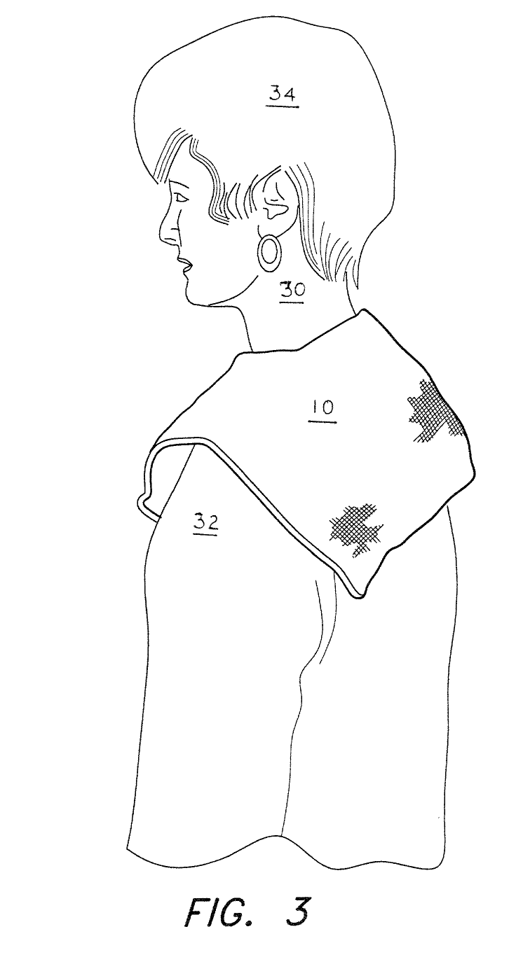

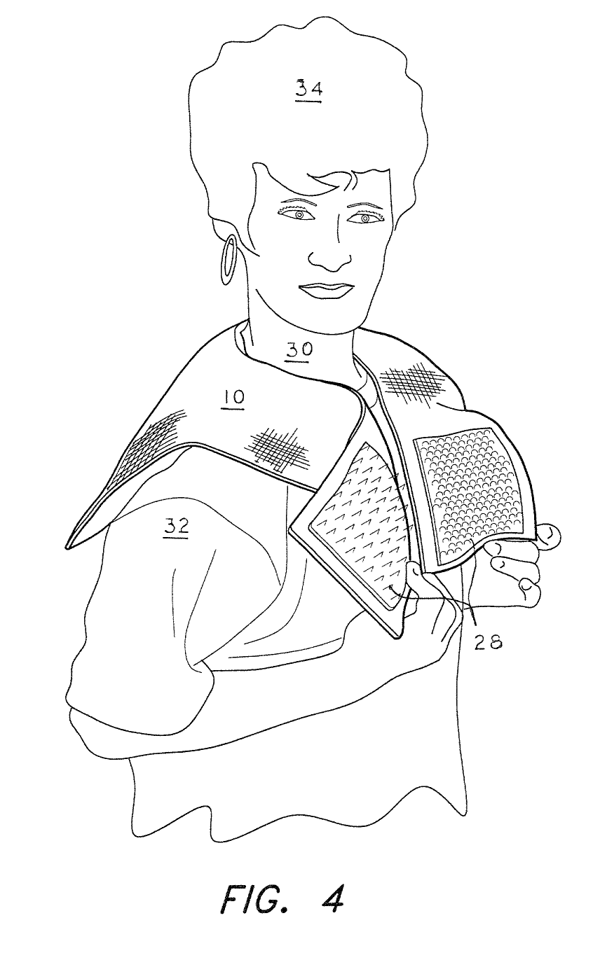

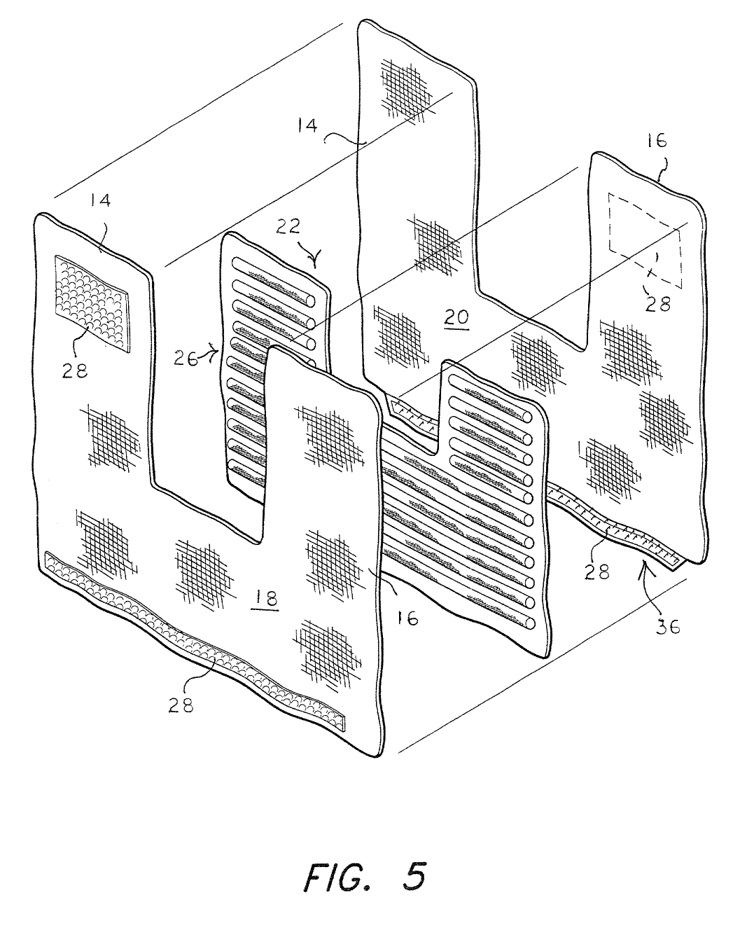

The present invention illustrated in FIGS. 1 through 5 is directed to a U-shaped therapeutic, fluid gel inserted, device which can be heated or cooled and secured around the neck or shoulders. The therapeutic pad 10 comprises a U-shaped cover 12 made from a fabric of cotton and polyester twill having two sleeves 14 and 16, a top surface 18 and a bottom surface 20. A gel filled insert 22 commensurate in shape is provided to fit inside the U-shaped cover 12. The composition of the gel 24 is a silicate and based on a formulation known in the art. The silicate gel 24 is provided between two sheets of very flexible plastic sheets and molded to either form a preferred undivided distribution of the gel 24 to the edges or optionally in rows 26 for minimizing segregation, but still distributed throughout the insert 22. Of particular importance is that gel 24 and the flexible plastic sheet are capable of being heated or cooled repeatedly without degeneration.

A hook and loop fastening patch 28 is affixed to each sleeve 14 and 16 proximate its end and on opposite sides for closure around the neck 30 or shoulder 32 of the person 34. A flap 36 permits the opening or closing of the pad 10 for insertion of gel filled insert 22. The remaining boundary of the therapeutic pad 10 is closed by stitching.

The heated or cooled therapeutic pad 10 can provide therapeutic relief while fastened around one's neck or shoulder. Other advantages reside in the following facts of (1) retaining heat or cold for at least an hour; (2) mobility of the wearer while wearing the pad; (3) reheatable and recoolable pad; (4) useful when driving; (5) wearable under coats; (5) does not interfere with household chores; and (6) allows use during walking, gardening and other activities.

It is to be understood that the present invention is not limited to the embodiment described above, but encompasses any and all embodiments within the scope of the following claims.

I claim:

1. A therapeutic pad comprising:
a U-shaped cover having a median portion between two perpendicular and parallel sleeves, a top surface and a bottom surface;
a gel filled flexible insert commensurate in shape to fit inside the U-shaped cover;
the gel filled flexible insert which is capable of being repeatedly heated or cooled; and
a hook and loop fastening patch affixed to each leg proximate its end and on opposite sides for closure around the neck or shoulder;
whereby the heated or cooled therapeutic pad can provide therapeutic relief while fastened around one's neck or shoulder.

2. The therapeutic pad according to claim 1, wherein the gel is a silicate gel.

3. The therapeutic pad according to claim 1, wherein the gel is microwavable.

4. The therapeutic pad according to claim 1, wherein the gel filled insert is made of flexible plastic.

5. The therapeutic pad according to claim 1, wherein an outside edge of the median portion of the top and bottom surfaces of the U-shaped cover has a closable opening for insertion or removal of the gel filled insert.

6. The therapeutic pad according to claim 5, wherein the closable opening has a flap.

7. The therapeutic pad according to claim 6, wherein the top surface portion and the bottom surface portion are sewn together except for the region of the flap.

8. The therapeutic pad according to claim 6, wherein the flap and the opposite surface have hook and loop fastening strips for closing the flap.

9. The therapeutic pad according to claim 1, wherein the cover is made of a cotton and plastic twill fabric.

10. The therapeutic pad according to claim 1, wherein the legs can be folded back, and the folded legs joined for portage or storage.
